(19) United States
(12) Patent Application Publication
(10) Pub. No.: US 2026/0369031 A1
(43) Pub. Date: Nov. 19, 2026

(54) LOW-RESOURCE INFERENCING USING COLOR CONTENT OF IMAGES

(71) Applicant: Plainsight Technologies Inc., Stuart, FL (US)

(72) Inventors: Venky Renganathan, Sammamish, WA (US); Samuel Wilt, Rochester, NY (US); Shanker Iyer, San Jose, CA (US); Lucas Mundim, Petrópolis, Rio de Janeiro (BR); Andrew Smith, Kent, WA (US)

(73) Assignee: Plainsight Technologies Inc., Stuart, FL (US)

(21) Appl. No.: 19/680,766

(22) Filed: May 18, 2026

Related U.S. Application Data
(60) Provisional application No. 63/807,384, filed on May 16, 2025.

(51) Int. Cl. G06V 10/75; G06T 11/10; G06V 10/25; G06V 10/44; G06V 10/94; G06V 20/40

(52) U.S. Cl. CPC G06V 10/751; G06T 11/10; G06V 10/25; G06V 10/44; G06V 10/759; G06V 10/945; G06V 20/46

(57) ABSTRACT

At least one non-transitory, computer-readable storage medium with instructions recorded thereon that, when executed by at least one processor of a computing device, cause the computing device to receive a series of images of a scene captured by an image capture device and arranged in temporal order, determine a first region of interest (ROI) in a first image corresponding to a first time, establish a first value for a statistical feature based on an analysis of the first ROI, determine a second ROI in a second image corresponding to a second time, establish a second value for the statistical feature based on an analysis of the second ROI, and compare the first and second values to determine whether the second value deviates from the first value by a first threshold amount.

### CROSS REFERENCE TO RELATED APPLICATIONS

The present application claims the benefit of U.S. Provisional Patent Application No. 63/807,384 for LOW-RESOURCE INFERENCING USING COLOR CONTENT OF IMAGES, filed May 16, 2025, the entire contents of which are incorporated herein by reference.

### BACKGROUND

Computer vision is a field of artificial intelligence (“AI”) that enables computing devices to interpret and process visual data, such as images and videos, in a manner similar to human vision. By leveraging machine learning (“ML”), particularly deep learning techniques, computer vision systems can recognize patterns, detect objects, classify images, and even generate new visual content. These capabilities are commonly achieved using ML models (or simply “models”) such as convolutional neural networks (“CNNs”), which are designed to efficiently capture spatial hierarchies and features in images. CNNs process images through multiple layers of filters that detect edges, textures, shapes, and more complex structures, allowing these models to develop a high-level understanding of the content of the visual data.

Models designed for computer vision are generally trained on large datasets of labeled images, enabling these models to generalize and make predictions on new, unseen visual data. Common applications of models include (i) image classification, where a model assigns a label to an image (e.g., identifying whether an image does or does not contain an object); (ii) object detection, where a model attempts to locate and classify one or more objects in an image; and (iii) image segmentation, where a model attempts to classify each pixel as either belonging or not belonging to an object, thereby delineating the object from the remainder of an image.

More advanced techniques, such as generative adversarial networks (“GANs”) and vision transformers (“ViTs”), have begun expanding the capabilities of computer vision, enabling more sophisticated tasks like image synthesis and real-time video analysis. These advancements are becoming widely used in fields such as medical imaging, autonomous driving, surveillance, and augmented reality.

### SUMMARY

According to an aspect of the present disclosure, at least one non-transitory, computer-readable storage medium with instructions recorded thereon may be provided. The instructions, when executed by at least one processor of a computing device, may cause the computing device to receive a series of images of a scene that are captured by an image capture device and that are arranged in temporal order. The instructions may cause the computing device to determine a first region of interest (ROI) in a first image in the series of images that corresponds to a first time in a series of times. The instructions may cause the computing device to establish a first value for a statistical feature based on an analysis of the first ROI in the first image. The instructions may cause the computing device to determine a second ROI in a second image in the series of images that corresponds to a second time in the series of times. The instructions may cause the computing device to establish a second value for the statistical feature based on an analysis of the second ROI in the second image. The instructions may cause the computing device to compare the first and second values to determine whether the second value deviates from the first value by a first threshold amount.

According to other aspects of the present disclosure, the at least one non-transitory, computer-readable storage medium may include one or more of the following features. The second time may be subsequent to the first time. The second ROI of the second image may have the same bounds as the first ROI of the first image. In response to a determination that the second value deviates from the first value by the first threshold amount, the instructions may cause the computing device to indicate, in a data structure, that the second image is an anomalous image, so as to document that an inferred state of the scene has changed between the first and second times. The instructions may further cause the computing device to receive an indication that an object is present in the first image and process the first image with an edge detection algorithm, so as to generate an outline of the object, wherein the first ROI may be representative of the outline of the object. The instructions may further cause the computing device to apply, to the first image, a machine learning model that is designed and trained to detect instances of the object. The instructions may further cause the computing device to receive, via an interface, input from a user that defines bounds of a user-defined region of the first image, wherein the first ROI may be representative of the user-defined region. The first image may be one of multiple images in the series of images for which the statistical feature is established, and the instructions may further cause the computing device to synthesize the first value based on multiple values of the statistical feature that are established for the multiple images. The first value may be representative of an average of the multiple values established for the multiple images. The instructions may further cause the computing device to determine a third ROI in a third image in the series of images that corresponds to a third time in the series of times that is subsequent to the first time but before the second time, wherein the third ROI of the third image may have the same bounds as the first ROI of the first image. The instructions may further cause the computing device to establish a third value for the statistical feature based on an analysis of the third ROI in the third image. The instructions may further cause the computing device to compare the first and third values to determine whether the third value deviates from the first value by a second threshold amount. In response to a determination that the third value does not deviate from the first value by the second threshold amount, the instructions may cause the computing device to indicate, in a data structure, that the third image is comparable to the first image, so as to document that an inferred state of the scene has not changed between the first and third times. The instructions may further cause the computing device to determine whether the third value deviates from the first value by the second threshold amount that is less than the first threshold amount. In response to a determination that the third value does deviate from the first value by the second threshold amount, the instructions may cause the computing device to establish the third value for the statistical feature as a reference against which subsequent values are compared.

According to another aspect of the present disclosure, at least one non-transitory, computer-readable storage medium with instructions recorded thereon may be provided. The instructions, when executed by at least one processor of a computing device, may cause the computing device to acquire a first image of a scene that is captured by an image capture device at a first time. The instructions may cause the computing device to identify a first region in the first image that corresponds to a predetermined portion of the scene. The instructions may cause the computing device to establish a first value for a statistical feature based on an analysis of pixel values of pixels that are located in the first region of the first image. The instructions may cause the computing device to acquire a second image of the scene that is captured by the image capture device at a second time that is subsequent to the first time. The instructions may cause the computing device to identify a second region in the second image that corresponds to the predetermined portion of the scene. The instructions may cause the computing device to establish a second value for the statistical feature based on an analysis of pixel values of pixels that are located in the second region of the second image. The instructions may cause the computing device to indicate, in a data structure, whether a state of the scene has changed, as determined based on a comparison of the second value to the first value.

According to other aspects of the present disclosure, the at least one non-transitory, computer-readable storage medium may include one or more of the following features. In response to a determination that the second value deviates from the first value by at least a predetermined amount, the instructions may cause the computing device to cause a machine learning model to be applied to the second image. The second image may be transmitted to a destination external to the computing device for application of the machine learning model. The instructions may further cause the computing device to convert the pixel values of the pixels that are located in the first region of the first image from a first color space to a second color space and convert the pixel values of the pixels that are located in the second region of the second image from the first color space to the second color space. The first color space may be a Red-Green-Blue (RGB) color space in which each pixel is represented by a red value, a green value, and a blue value, and the second color space may be a Hue-Saturation-Value (HSV) color space in which each pixel is represented by a hue value, a saturation value, and a brightness value. The statistical feature may be a mean hue value, a mean saturation value, a mean brightness value, or a set of mean hue, saturation, and brightness values.

According to another aspect of the present disclosure, a computer-implemented method of inferring a state of a scene or detecting a presence in the scene based on first and second values of a statistical feature of pixel values of pixels in a first and second image may be provided. The method may comprise determining a first value for the statistical feature based on an analysis of pixel values of pixels that are located in a first region of the first image. The method may comprise determining a second value for the statistical feature based on an analysis of pixel values of pixels that are located in a second region of the second image. The method may comprise determining whether the second value deviates from the first value by at least a threshold amount.

According to other aspects of the present disclosure, the computer-implemented method may include one or more of the following features. In response to a determination that the second value deviates from the first value by at least the threshold amount, the method may comprise causing a machine learning model to be applied to the second image. The method may further comprise presenting, on an interface, a representation of the first image and receiving, from the interface, an indication of the first region in the first image.

### BRIEFDESCRIPTIONOFTHEDRAWINGS

Detailed descriptions of implementations of the present invention will be described and explained through the use of the accompanying drawings.

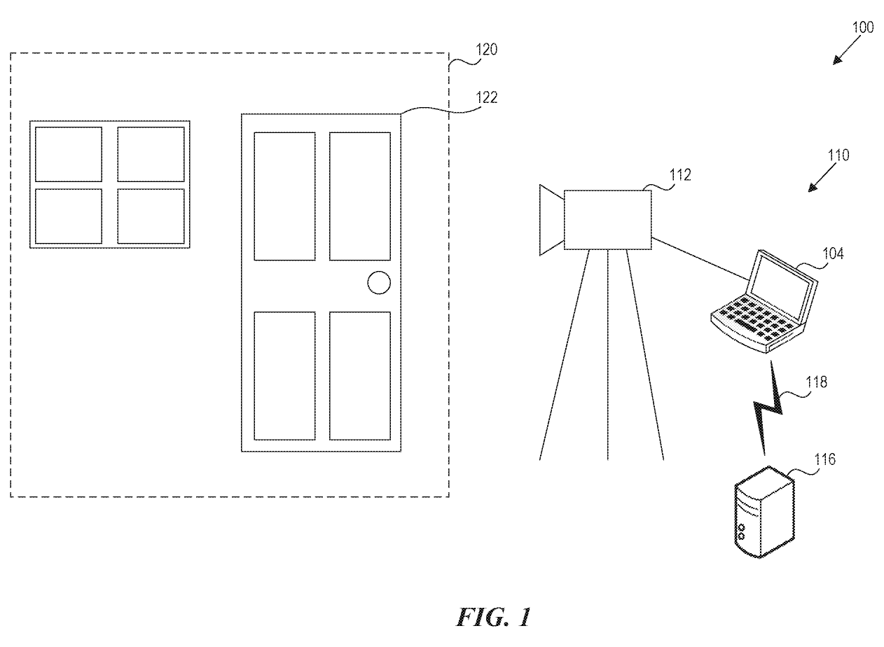

FIG. 1 illustrates a diagram of an example of an image analysis system that can be used in certain embodiments.

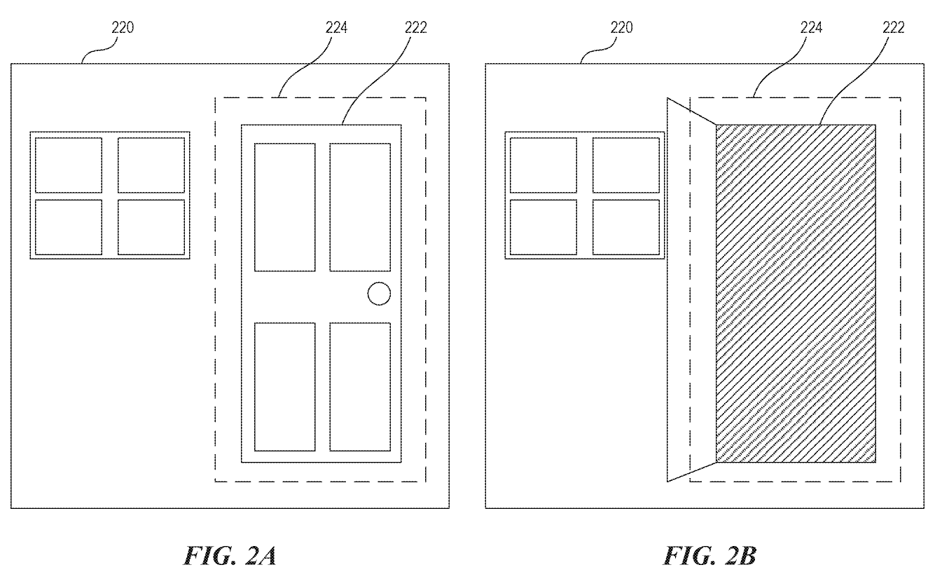

FIGS. 2A and 2B illustrate a scene 220 undergoing a change of state that can be inferred in certain embodiments.

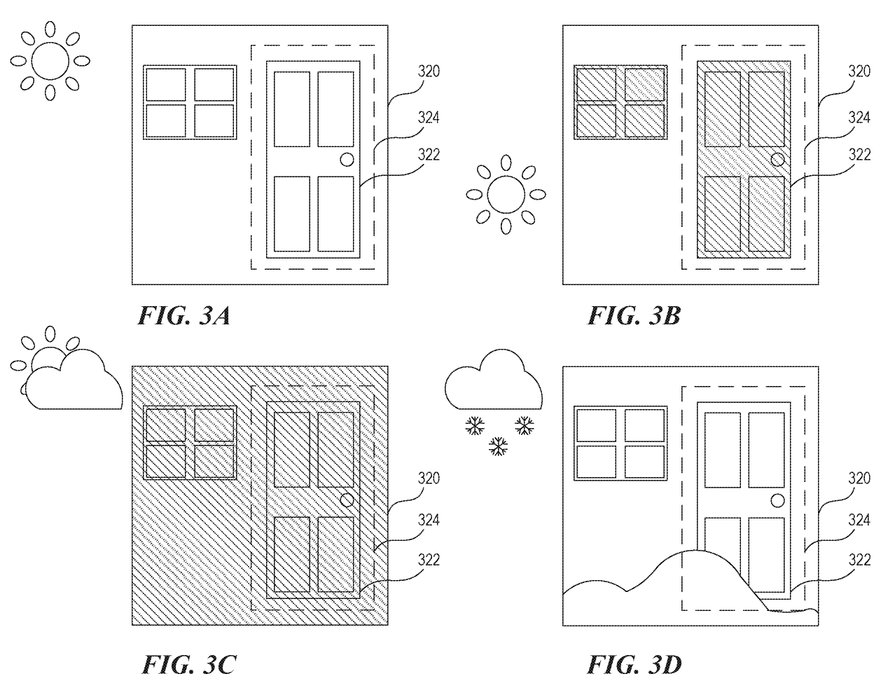

FIGS. 3A-3D illustrate a scene in which a gradual change in the scene can be differentiated from a change in the state of the scene.

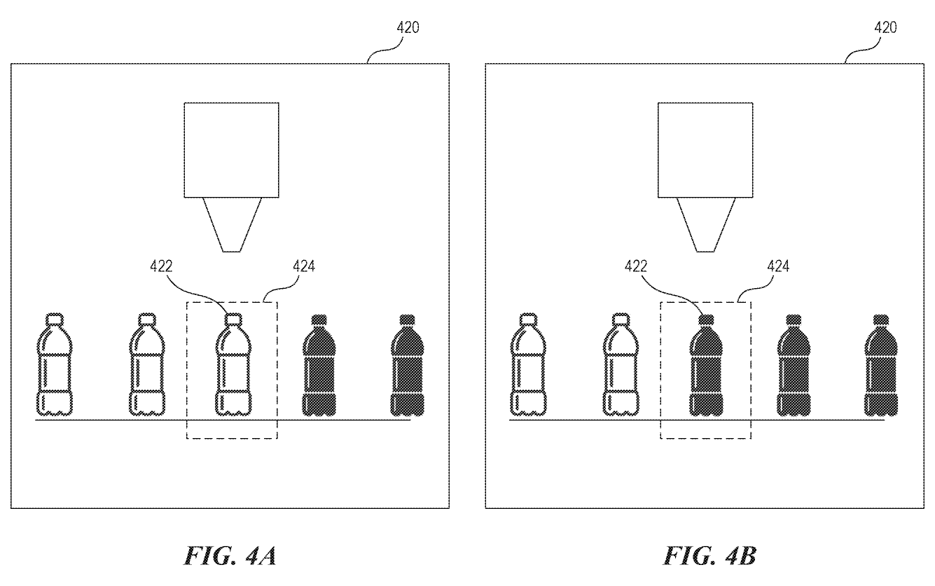

FIGS. 4A and 4B illustrate a scene in which a specific state of the scene can be detected in certain embodiments.

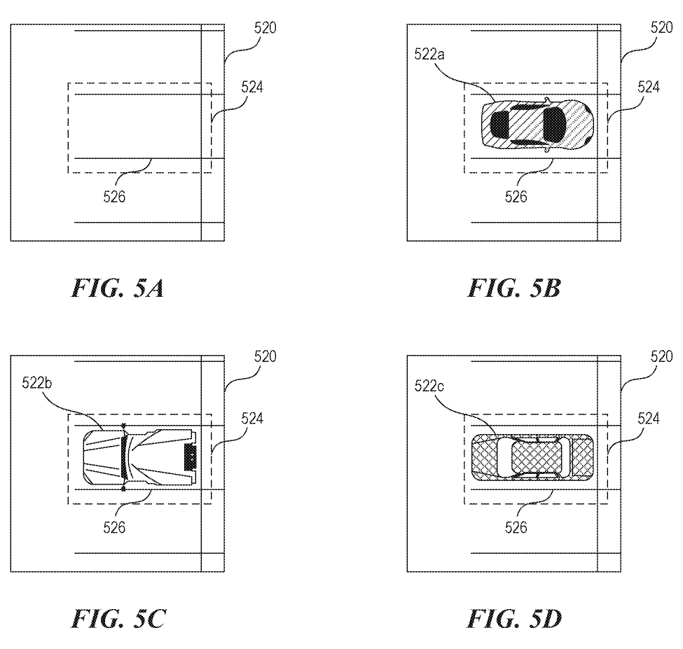

FIGS. 5A-5D illustrate a scene in which multiple specific states of the scene can be differentiated in certain embodiments.

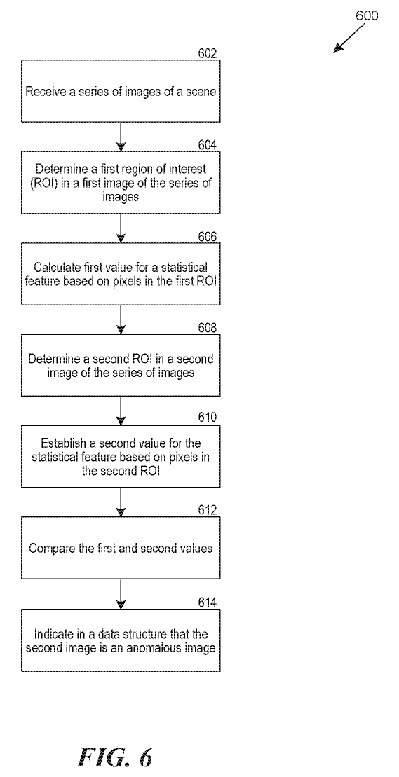

FIG. 6 illustrates a flow diagram of a method of inferring information about a region of one or more images by examining the color content of those images through an analysis of pixel data.

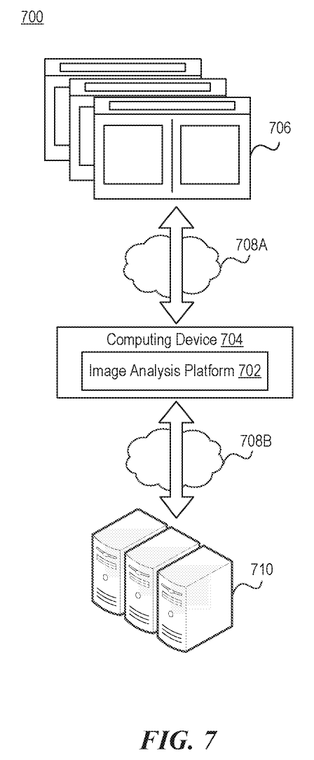

FIG. 7 illustrates a network environment that includes an engagement tracking platform that is executed by a computing device.

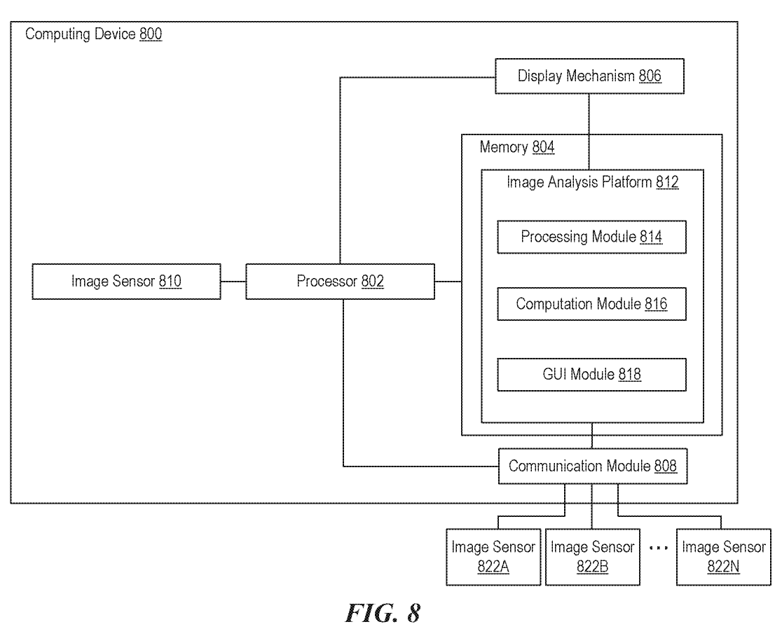

FIG. 8 illustrates an example of a computing device that is able to implement an engagement tracking platform that is designed to evaluate the engagement of a human with a computer program executing on a computing device.

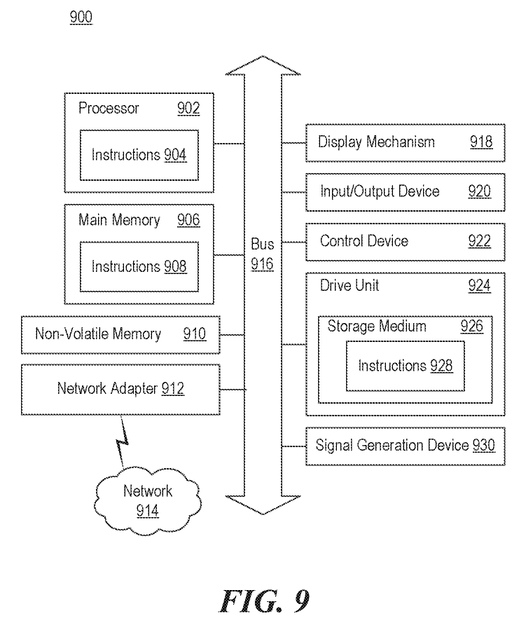

FIG. 9 includes a block diagram illustrating an example of a processing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Sophisticated models designed for computer vision, especially those with deep learning architectures like CNNs and ViTs, require substantial computational resources due to their complex structures and large-scale matrix operations. Training these models generally involves processing vast amounts of visual data, performing millions of mathematical computations, and optimizing tens - if not hundreds or thousands - of parameters. Meanwhile, applying these models for inferencing purposes generally involves using those optimized parameters to better understand the content of visual data. These tasks are infeasible, if not impossible, to perform using standard central processing units (“CPUs”). Instead, dedicated hardware, such as graphics processing units (“GPUs”) or tensor processing units (“TPUs”), is commonly used to perform these tasks. The parallel processing capabilities of GPUs and TPUs are especially well-suited for computer vision tasks.

However, the dependence on dedicated hardware makes sophisticated models unsuitable for scenarios where computational resources are limited or unavailable. For example, deploying a complex CNN on a computing device with limited processing power can lead to significant latency and energy consumption issues. Researchers have attempted to address this concern by employing techniques such as model compression and quantization and by implementing “lightweight” architectures. Although these steps may help reduce computational overhead, implementing sophisticated models remains a significant challenge in environments with power, memory, or processing constraints - such as Internet of Things (“IoT”) devices, low-cost consumer electronic devices, and remote locations with limited connectivity.

Introduced here, therefore, is an algorithmic approach to analyzing color within a region of an image and then inferring information regarding the content of the region based on the color. As further discussed below, an image analysis platform (or simply “platform”) may initially obtain an image and then identify a region of interest (“ROI”) within the bounds of the image. The platform can then establish whether pixels in the ROI are represented in a given color space (e.g., the Hue-Saturation-Value or “HSV” color space). If the pixels are not represented in the given color space (e.g., are represented in the Red-Green-Blue or “RGB” color space rather than the HSV color space), then the platform can convert the pixels to the given color space. Thereafter, the platform can compute one or more statistical features based on the pixels, so as to establish a baseline state (also called a “normal state” or “default state”) for the ROI in terms of color content. Assume, for example, that the given color space is the HSV color space, in which pixels are described in terms of hue, saturation, and brightness. In such a scenario, the platform may extract values for one or more statistical features, such as mean, mode, variance, or standard deviation, based on the hue values, saturation values, or brightness values associated with the pixels in the ROI.

After baseline values are established for the ROI, images captured later in time - also called “subsequent images” - can be analyzed by the platform in a similar manner. For a subsequent image, the platform can identify the ROI, convert pixels in the ROI to the given color space, and then compute the same statistical features based on the values (e.g., the HSV values) associated with the pixels in the ROI. These statistical features can then be compared against the baseline state in order to determine whether there has been a change in the color content of the ROI. Deviations in the color content beyond a threshold - which may be predetermined, defined algorithmically, or defined through trial and error (e.g., during setup) - may be inferred to be representative of a change in the underlying scene that is being imaged.

This approach is useful in situations where sophisticated computer vision models are impractical. Calculating statistical features based on pixel values - even complex statistical analyses - can be far less computationally intensive than more advanced computer vision models, even ones with “lightweight” architectures. Additionally, this approach can be combined with more advanced computer vision models. For example, it could be used as a first step in identifying images that are - or might be - considered “relevant” for certain computer vision tasks, with only those relevant images being sent for analysis by more sophisticated models. This decreases the amount of computation needed and the amount of power consumed by the device, since only a subset of images would need to be processed by a more sophisticated model. This more sophisticated model could even be implemented by a separate device with more dedicated resources, such as GPUs or TPUs. In such a scenario, this approach can decrease the amount of data that must be transmitted to the separate device, thus saving energy and network usage.

Additionally, this approach can be used in situations where more advanced computer vision techniques are unnecessary. For example, this approach may be viable when the computer vision task is to detect a change in state, such as detecting a state of a given object (e.g., whether a door is open or shut) or detecting whether a given object is present (e.g., whether a vehicle is, or is not, located in a parking spot). The device can make this determination based on the statistical features derived from the pixel values. In some embodiments, the device may take additional action based on the state, while in other embodiments, the device transmits the state to one or more other computing devices for further analysis or action.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Terminology

References in the present disclosure to “an embodiment” or “some embodiments” means that the feature, function, structure, or characteristic being described is included in at least one embodiment. Occurrences of such phrases do not necessarily refer to the same embodiment, nor do they necessarily refer to alternative embodiments that are mutually exclusive of one another.

The term “based on” is to be construed in an inclusive sense rather than an exclusive sense. That is, in the sense of “including but not limited to.” Thus, the term “based on” is intended to mean “based at least in part on” unless otherwise noted.

The terms “connected,” “coupled,” and variants thereof are intended to include any connection or coupling between two or more elements, either direct or indirect. The connection or coupling can be physical, logical, or a combination thereof. For example, elements may be electrically or communicatively connected to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing multiple tasks.

When used in reference to a list of items, the word “or” is intended to cover all of the following interpretations: any of the items in the list, all of the items in the list, and any combination of items in the list.

### Overview of Approaches to Inferencing Changes Based on Color Content Analysis

FIG. 1 illustrates a diagram 100 of an example of an image analysis system 110 (or simply “system 110”) that can be used in certain embodiments. The system 110 can be used, for instance, to analyze images of a scene 120 to infer information pertaining to objects 122 contained in the scene 120. The system 110 can include a camera 112, a low-resource computing system 104 (also called the “lightweight system 104”), and a high-resource computing system 116 (also called the “heavyweight system 116” or “advanced system 116’’). The camera 112 can be configured to capture images of a scene 120. The images may be representative of frames of a video or static images that are captured at periodic intervals. The images can initially be received by the lightweight system 104. This can be a system that has strict resource requirements, such as low processing capability, low memory, low power consumption, or the like. Examples include IoT devices (e.g., endpoints of surveillance systems designed for home or enterprise environments), consumer electronic devices such as mobile phones, or any system that has limited resources, bandwidth, or connectivity or is operating in a low-resource mode, such as a power saving mode. The lightweight system 104 can perform a color analysis on the images, as described in detail below. Through the color analysis, information about the content of the images can be inferred, including a change of state of the scene 120 and its objects 122 between images, based on an analysis of the color of pixels in the image(s).

Note that, in some embodiments, the camera 112 is a component of the lightweight system 104. For example, in embodiments where the lightweight system 104 is a mobile phone, the camera 112 could be a front- or rear-facing camera of the mobile phone. In other embodiments, the camera 112 is distinct from, but communicatively connected to, the lightweight system 104. For example, if the lightweight system 104 is a laptop computer, the camera 112 may be representative of a separate video camera (e.g., a webcam) that is communicatively connected to the laptop computer.

In some embodiments, the lightweight system 104 is connected to an advanced system 116. The advanced system 116 can be any system that can access more resources, such as higher processing power and/or advanced components such as a GPU and/or TPU. The lightweight system 104 can send images to the advanced system 116 for more advanced analysis, such as processing using ML models or advanced computer vision techniques. For example, the lightweight system 104 may use color analysis to determine whether a change of state in the scene 120 or its objects 122 has occurred between a first and second image, and in response to inferring that there has been a change in state, send at least the second image to the advanced system 116 for advanced analysis, such as performing object detection, semantic segmentation, object counting, and the like. This decreases the amount of resources to detect changes in a scene, since only relevant images (e.g., from a video stream) are sent to the advanced system 116 for advanced analysis.

In some embodiments, the advanced system 116 performs a color analysis. In an example, the lightweight system 104 performs, a color analysis which indicates a change of state in the scene 120 or its objects 122 as represented in certain images. The lightweight system 104 can send these certain images to the advanced system 116 for further analysis and characterization, which can include performing a color analysis on the certain images. The advanced system 116 can then send data or images to other computing systems (not shown in FIG. 1) that can perform more analyses.

Note that the lightweight system 104 need not always be connected to an advanced system 116. As further discussed below, there may be scenarios where the color analysis performed by the lightweight system 104 is sufficient to reliably predict a change in state in the scene 120 or its objects 122. In such scenarios, inferences made by the lightweight system 104 based solely on analysis of the color content of images of the scene 120 may be sufficient.

In embodiments where the lightweight system 104 is connected to the advanced system 116, the lightweight system 104 can be connected to the advanced system 116 by a wired connection or a wireless connection. In FIG. 1, the lightweight system 104 is shown as connected to the advanced system 116 via a wireless connection 118. The wireless connection 118 may be representative of a single point-to-point connection (also called a “direct connection”), which may reduce latency and simplify network configuration, or a combination of connections, for example, via Wi-Fi, cellular networks (e.g., 4G LTE, 5G), satellite links, mesh networks, and the Internet. For example, the selection of a particular wireless protocol or combination of protocols may be based on considerations such as available bandwidth, latency requirements, power consumption constraints, range limitations, or environmental factors. To illustrate, in scenarios where the lightweight system 104 is battery-powered, a low-power wireless protocol such as Bluetooth Low Energy or Zigbee may be preferred to extend battery life. In other scenarios where higher data throughput is desired, Wi-Fi or cellular connections may be more suitable.

In some embodiments, the lightweight system 104 is identified with and/or integrated into the advanced system 116, such as when different parts of a single computing system performs both color analysis and more advanced analysis of images. For example, a single computing device may operate in a power-saving mode in which color analysis is performed until a change in state of the scene 120 is detected, at which point the computing device may perform more advanced analysis on the associated image(s). Although the system 110 is shown to include one camera 112, one lightweight system 104, and one advanced system 116, the system 110 can in general include any number of such components, connected in any topology and by any means. For example, in some embodiments, multiple cameras image the scene 120 from different perspectives and infer information about the scene 120 using different and independent variations of the techniques described below. In such embodiments, the system 110 can determine a final inference of information about the scene 120 based on the data collected from each perspective.

As further discussed below with respect to FIG. 7, the color analysis can be performed by a computer program - called an “image analysis platform” - that is executing on the lightweight system 104 and/or the advanced system 116.

FIGS. 2A and 2B illustrate a scene 220 undergoing a change of state that can be inferred in certain embodiments. The scene 220 can be captured by an image sensor of an image capture device, such as the camera 112 of system 110 described with respect to FIG. 1, which can produce one or more images depicting the scene 220. Images of the scene 220 can be processed by one or more computing systems, such as the lightweight system 104 and/or the advanced system 116 of system 110. In FIGS. 2A-2B, the scene 220 includes a door 222 that can be either open or closed. Said another way, the scene 220 includes a door 220 that can - at least at a high level - be considered as in one of two states, namely, an open state and a closed state.

An image analysis platform, such as the one discussed below with respect to FIG. 7, can process images of the scene 220 in order to infer information about the scene 220 and/or a region of interest (ROI) 224, such as a change in state (e.g., from the closed state to the open state, or from the open state to the closed state).

The image analysis platform can also determine the ROI 224 for the scene 220. At a high level, the ROI 224 may be representative of an area in which color analysis is used to infer information regarding content of an image, and therefore the ROI 224 may have bounds that define the pixels that are to be used to infer the information. The ROI 224 can be determined manually by a human user, such as by presenting an image on a graphical user interface (or simply “interface”) and then receiving, through the interface, input that is an indication of an ROI.

The ROI 224 can also be determined algorithmically. For example, the ROI 224 can be determined using computer vision techniques such as object detection, edge detection, and/or image segmentation. In another example, the ROI 224 can be determined statistically, such as by acquiring multiple images of the scene in different states and determining the pixels with the highest deviations, such as pixels with a color deviation that exceeds a threshold. The threshold could be measured in static terms (e.g., a predetermined amount of hue, saturation, or intensity if the pixels are represented in the HSV color space) or dynamic terms (e.g., a dynamically determined percentage of hue, saturation, or intensity if the pixels are represented in the HSV color space). In some embodiments, the ROI 224 is determined using a combination of approaches, such as user-guided computer vision techniques. In some embodiments, the system determines multiple ROIs for a single scene. Each ROI in a set of images can be evaluated independently using the techniques described below.

The image analysis platform can infer information regarding the content of an image (e.g., whether there has been a change in state in comparison to an earlier-in-time image) by comparing one or more statistical features that are derived from pixel values in the ROI 224 in the image. For example, the image analysis platform can receive a first image of the scene 220 in which the pixel data is represented in a given color space, such as the HSV color space, where the color of each pixel is represented using numerical values for hue, saturation, and value. The image analysis platform can then calculate one or more statistical features for the first image. These statistical features may be stored by the image analysis platform and treated as baseline values against which future statistical features are compared. Accordingly, upon receiving a second image that is captured subsequent to the first image, the image analysis platform can calculate the same statistical features for the second image. The image analysis platform can then infer information about the scene 220 that is captured in the first and second images, such as whether there has been a change of state for an object in the scene 220, based on a comparison of the statistical features calculated for the first image with the statistical features calculated for the second image. For example, if the statistical features calculated for the second image differ from the statistical features calculated for the first image by at least a threshold amount, the image analysis platform can infer that the content of the scene 220 has changed.

Referring to FIGS. 2A-B, assume that the image analysis platform initially receives a first image of the scene 220 in which the door is closed as shown in FIG. 2A and then subsequently receives a second image of the scene 220 in which the door 222 is open as shown in FIG. 2B. The image analysis platform can use the first image - or a set of images that includes the first image - to calculate a baseline value for each of one or more statistical features based on either an analysis of the entire first image or an analysis of the pixels in the ROI 224. For example, the image analysis platform may compute a mean and standard deviation of color values.

Thereafter, the image analysis platform may receive the second image of the scene 220 that is captured subsequent to the first image of the scene 220. As shown in FIG. 2B, the door 222 is now open at the time at which the second image is captured. The image analysis platform can calculate values for the same one or more statistical features as those calculated for the first image. Again, these statistical features may be based on either an analysis of the entire second image or an analysis of the pixels in the ROI 224. The image analysis platform can then compare the statistical features calculated for the second image to the statistical features calculated for the first image, so as to establish whether color content of the second image (or its ROI 224) is different than the first image (or its ROI 224). If the statistical features calculated for the second image differ from the statistical features calculated for the first image by at least a threshold amount, the image analysis platform can establish that the color content has changed, and thus infer that there has been a change in the state of the scene 220. Here, for example, the image analysis platform may infer that changes in the color content of the ROI correspond to changes in the state of the door 222 (i.e., from the open state to the closed state, or from the closed state to the open state), and therefore can gain insights into the state of the door 222 without monitoring the door 222 through more sophisticated mechanisms (e.g., ML models that are trained for object detection, edge detection, object segmentation, etc.).

In some embodiments, the image analysis platform implements a transformation on the pixel data before calculating values for the one or more statistical features. For example, the image analysis platform can receive images that contain pixels with data represented in a given color space and subsequently transform the data into values of a different color space. Assume, for example, that the image analysis platform receives an image with pixel values that are represented in an RGB color space. In such a scenario, the image analysis platform can transform the pixel values from the RGB color space into an HSV color space before statistical analysis is performed, such that the statistical features (e.g., mean, standard deviation, etc.) are representative of values in the HSV color space.

There are several benefits to this approach. First, transformations are relatively easy - and computationally inexpensive - to implement, and therefore it can be beneficial from a computational resource perspective to transform pixel values into a given color space that the image analysis platform is designed to process.

Second, there are some scenarios where changes in the scenes are more readily discernible in one color space versus another color space. For example, the HSV color space separates hue and intensity and represents those as separate values. At certain times of the day, one of these may change more than the other. For example, in the evening, the intensity may change more than the hue. Transforming the pixel values into the HSV color space allows the image analysis platform to separately analyze these measures. For example, the image analysis platform may calculate the mean intensity value and mean hue value for an ROI, but the thresholds for mean and intensity could be different (e.g., the intensity threshold could be higher than the hue threshold, and therefore a larger change in intensity may be necessary to provoke a determination that content of the scene has changed).

Note that the image analysis platform can implement transformations into other color spaces, such as the CYMK color space, L*a*b* color space, LMS color space, and/or LCh color space. The color space into which the image analysis platform transforms the pixels values of incoming images may depend on which color space is most useful, for that scene specifically, in predicting changes. The image analysis platform can also implement other transformations on the pixel values either before or after performing statistical analysis. In some embodiments, the image analysis platform only performs transformations on a subset of the pixels in an image, such as the pixels inside the ROI 224. This could be done to conserve computational resources or to hasten the statistical analysis.

In some embodiments, the image analysis platform performs a calibration operation, in which the image analysis platform receives a set of initial images of the scene 220 and determines baseline values for one or more statistical features based on an analysis of the set of images (and more specifically, based on an analysis of the pixels in the ROIs 224 of the set of initial images). This could include any type or combination of statistical features, such as mean, median, mode, range, variance, standard deviation, and the like. Furthermore, the image analysis platform can independently choose statistical features for each dimension of the pixel data (e.g., three dimensions for the HSV color space) or can choose to calculate one or more combined statistical features, each of which incorporates multiple independent dimensions. Once the baseline values of the statistical features have been calculated for the pixels in the ROIs 224 of the set of initial images, the image analysis platform can infer a change in state of the scene 220 if a subsequent image has subsequent values for the statistical features that deviate from the baseline values by at least a threshold amount.

As mentioned above, the image analysis platform can compare the distance between the subsequent values and the baseline values to a threshold distance. The threshold distance can be applied to the color space in various ways. For example, the distance between values of the statistical features in the color space of the image can be treated as a three-dimensional distance (e.g., applying Pythagorean theorem and/or a Euclidean distance metric, or any other distance metric, to the points in the three-dimensional color space). In another example, the distance is calculated for each dimension independently (e.g., the change of state being inferred if one, two, or three dimensions of the subsequent values deviate from the baseline values by a threshold distance, where the threshold distance can be different for each dimension). In some embodiments, the threshold is determined by identifying a region of values near the baseline values of the statistical features. For example, the image analysis platform can infer a change of state if the subsequent values are outside of an ellipsoidal region defined by the baseline values of the statistical features (e.g., an ellipsoid defined by having a center at the baseline mean values and principal semi-axes defined by the baseline standard deviation values). The threshold can be predetermined, for example by using threshold distances based on a chosen intended scene or intended inferred information, or by using thresholds set by users. The threshold can be determined based on measured baseline values of statistical features, such as using the baseline standard deviation values as a threshold distance.

In some embodiments, the image analysis platform varies the number of initial images used in the calibration operation. For example, the image analysis platform can use few or no initial images, and instead compute one or more statistical features of images as those images are received and dynamically establish the baseline values for the statistical features as images are acquired in a “rolling” manner. The image analysis platform may also dynamically determine a threshold, for example, by using a statistical classifier such as a Bayesian approach or k-nearest neighbor, to detect outliers (e.g., that may be representative of changes of state) and differentiate anomalous states from normal states.

FIGS. 3A through 3D illustrate a scene 320 in which a gradual change in the scene 320 can be differentiated from a change in the state of the scene 320. The image analysis platform can change and/or adapt the baseline values for statistical features over time. FIGS. 3A through 3D show the scene 320 that includes a door 322, where no change in the state of the door 322 has occurred (e.g., the door 322 stays closed) but the color content within the ROI 324 varies due to gradual changes over time. For example, FIG. 3A shows an initial configuration of the scene 320 and ROI 324 from which baseline values of one or more statistical features can be calculated. FIG. 3B shows the scene 320 in the evening, such that the colors are darker and shadows have been cast in the ROI 324. FIG. 3C shows the scene 320 after clouds have covered the sun, darkening all colors in the scene 320. FIG. 3D shows the scene 320 during snowfall, when snow has partially obscured the door 322 in the ROI 324. The image analysis platform can be configured to detect changes that occur over extended intervals of time (e.g., hours, days, weeks, or months) and corresponding drifts in the subsequent values of the statistical features, and then update the baseline values to reflect these drifts. For example, the image analysis platform may update the baseline values of statistical features (e.g., by perform the calibration operation again using a more recent set of images, which may overlap with the prior set of initial images) on a periodic basis (e.g., hourly, daily, weekly, or monthly).

Additionally, or alternatively, the image analysis platform could update the baseline values in response to detecting that the subsequent values of the statistical features differ from the baseline values for an extended period of time, but are still within the threshold of the baseline values. Said another way, in response to detecting that the values calculated for one or more statistical features have begun deviating from the corresponding baselines by increasing amounts over time, the image analysis platform may dynamically reestablish the baseline values. Thus, the image analysis platform may monitor the statistical features in an ongoing manner to establish whether one or more values are representative of a trend that indicates reestablishing the baseline values is appropriate. The image analysis platform could set a second threshold that is less than the first threshold and could update the baseline values if a single subsequent value or a series of subsequent values (e.g., at least a predetermined number of consecutive values or at least a predetermined fraction of values over an interval of time) exceed the second threshold but do not exceed the first threshold.

Such an approach also allows the image analysis platform to learn over time. For example, assume that an image analysis platform receives feedback that it is generating false positives (i.e., inferring a change in state where no change has occurred, such as when the images have different values for one or more statistical features but not due to a change in state). This feedback could be provided, by a user, after the conclusion of a validation operation that is completed after the calibration operation, or this feedback could be provided, by the user, during runtime as the image analysis platform performs its image analysis.

To update the baseline values, the image analysis platform may include more images in the set of initial images that are used to initially establish the baseline values. Normally, this is done only if the feedback is provided immediately or shortly after the calibration operation is completed. If the feedback is provided during runtime, the image analysis platform could add more recent images to the initial set of images or create an entirely new set of images to be used to update the baseline values. Regardless of its approach, the image analysis platform can update the baseline values or corresponding thresholds, such that the false positives are within a desired tolerance and the image analysis platform is able to more accurately and reliably predict changes in state. Accordingly, the image analysis platform may “tune” its approach to image analysis by adjusting the statistical features used for comparison, adjusting the thresholds used for comparison, or adjusting the statistical features and thresholds used for comparison. Additionally, or alternatively, the image analysis platform could receive feedback, from a user, that identifies which images include a change in state and then update the baseline values accordingly. Thus, the image analysis platform may calculate baseline values using a modified set of initial images that only includes images that have been identified, by users, as not showing a change in state. In a sense, the image analysis platform may mimic supervised learning that is more commonly employed in machine learning.

FIGS. 4A and 4B illustrate a scene 420 in which a specific state of the scene 420 can be detected in certain embodiments. With its approach to image analysis, the image analysis platform can also be tasked with inferring whether a scene or an object in the scene has reached a state rather than deviated from it. FIGS. 4A and 4B shows an example in which the portion of the scene 420 inside ROI 424 changes by having an empty bottle 422 as shown in FIG. 4A be filled with a liquid as shown in FIG. 4B. The image analysis platform can be calibrated using an initial image that includes a filled bottle within the ROI 424 or a set of initial images, each of which includes a filled bottle within the ROI 424, to determine the baseline values for one or more statistical features. Then, the image analysis platform can infer whether the scene 420 has reached a target state (e.g., where the bottle 422 is filled) when subsequent values for the statistical features are within a threshold of the baseline values. Accordingly, baseline values for one or more statistical features can be established so as to allow the image analysis platform to detect when a scene or object has exited a given state and to detect when the scene or object has entered the given state (e.g., determine when the color content indicates that the bottle 422 is not empty versus when the color content indicates that the bottle 422 is filled).

FIGS. 5A-D illustrate a scene 520 in which multiple specific states of the scene 520 can be differentiated in certain embodiments. In some embodiments, the image analysis platform is calibrated with multiple baseline values or multiple sets of baseline values, each of which corresponds to a different one of multiple states, and is able to infer whether the ROI corresponds to one of the multiple states. FIGS. 5A-D show the scene 520 in which the state of the scene 520 changes by having no cars parked in a parking space 526 and having one of three cars 522a, 522b, 522c parked in the parking space 526. Referring to FIGS. 5A-D, the image analysis platform can be configured to perform four calibration operations corresponding to four sets of initial images, one for each state of the scene 520 inside the ROI 524 as pictured in FIGS. 5A-D. The image analysis platform can calculate baseline values for one or more statistical features for each of the four states, resulting in either four baseline values or four sets of baseline values, and then use those baseline values to infer which of the four states the scene 520 is presently in.

Accordingly, the image analysis platform may compute baseline values for the state in which the parking space 526 is empty, and therefore is one of the four predefined states. Alternatively, the image analysis platform could compute baseline values for the three states corresponding to the three cars 522a, 522b, 522c and not compute baseline values for the state in which the parking space 526 is empty. In such a scenario, the “empty state” may be considered an undefined state for which no baseline values are established. In the event that the image analysis platform determines that a subsequent value computed for a subsequent image is not within a threshold of the baseline values established for the three predefined states, the image analysis platform may infer that the ROI 524 is in an undefined state and make an appropriate assumption (e.g., that the parking space 526 is empty).

In some embodiments, the image analysis platform is configured such that, in response to detecting that a subsequent value is not within a threshold of any of the baseline values, the image analysis platform infers that the ROI 524 is in a new state that does not correspond to one of the predefined states. In response to detecting the new state, the image analysis platform may complete a calibration operation using one or more images that correspond to the new state, in order to document the new state. Assume, for example, that the image analysis platform has established baseline values for vehicles that are colored white, black, and gray as those are common vehicle colors. If the image analysis platform discovers a new state (e.g., a red vehicle), the image analysis platform can establish baseline values for the same statistical features so that the new state can be considered alongside the predefined states when subsequent images are analyzed. Normally, a user will identify or label the new state. For example, the image analysis platform may indicate, via an interface, that a new state has been discovered and then the user may be prompted to describe the new state (e.g., “This is a red vehicle.”). The description - or information gleaned from the description - may be used by the image analysis platform to label the new state.

In some embodiments, the image analysis platform uses the baseline values established for the one or more statistical features to determine thresholds for inferring a change in state. For example, the image analysis platform can determine baseline mean values corresponding to each of the four states depicted in FIGS. 5A-D , and the image analysis platform can define the threshold as being a certain fraction of the distance between two baseline mean values corresponding to two distinct states. The image analysis platform can use other strategies to partition the color space, such as generating Voronoi cells around baseline mean values, to determine the thresholds for the calibrated states. The image analysis platform may even use a combination of strategies to define thresholds for the states.

### Approaches to Inferring Changes in State Through Analysis of Color Content

FIG. 6 illustrates a flow diagram 600 of a method of inferring information about a region of one or more images by examining the color content of those images through an analysis of pixel data. This can be performed by an image analysis platform as further discussed with respect to FIG. 7. The image analysis platform may reside on, or be connected to, a computing system that includes one or more image capture devices. For example, the image analysis platform may be embodied as a computer program that is executing on a computing system that includes an image capture device. As another example, the image analysis platform may be embodied as a computer program that is executing on a first computing system that is communicatively connected to a second computing system that includes an image capture.

At 602, the image analysis platform can receive a series of images of a scene that are captured by an image capture device and that are arranged in temporal order, such that each image in the series of images is associated with a different one of a series of times. For example, the image capture device can receive a video that includes multiple frames of the scene, where each frame is representative of an image and is taken at a corresponding time in a series of times.

At 604, the image analysis platform can determine a first region of interest (ROI) in a first one of the series of images that corresponds to a first one of the series of times. For example, the image analysis can determine the first ROI in a frame of the video. In some embodiments, the first ROI is a predetermined portion of the first image. For example, the system can identify a first region in the first image (e.g., based on spatial relationship to the bounds of the first image or a center point of the first image) that corresponds to a predetermined portion of the first image, and therefore a predetermined region of the scene.

In some embodiments, the image analysis platform can process the first image to determine a first ROI. For example, the image analysis platform may receive an indication that an object is present in the first image. This could occur in several ways. In some embodiments, the image analysis platform receives input, from a user, that indicates that the object is present in the first image. For example, the user could select the first image through an interface and then specify (e.g., by selecting a label or inputting a description) that the first image includes the object.

In other embodiments, the image analysis platform may implement a more sophisticated approach that relies on, for example, object detection. For example, the image analysis platform can apply an ML model that is trained to detect instances of the object to the first image. The ML model may produce, as output, a bounding box that includes the object, and the image analysis platform may use the bounding box as the ROI or generate the ROI based on the bounding box. As another example, the image analysis platform could process the first image with an edge detection algorithm, so as to generate an outline of the object. The first ROI can then be representative of, or at least based on, the outline of the object as determined by the edge detection algorithm.

As mentioned above, the image analysis platform may determine the first ROI based on user instruction in some embodiments. For example, the image analysis platform can receive, via an interface, input from a user that defines the bounds of a user-defined region of the first image. The first ROI can be representative of, or at least based on, the user-defined region. In another example, the image analysis platform can present a representation of the first image on an interface and receive, through the interface, an indication of the first ROI. For instance, the user may be able to define (e.g., draw) the bounds of the first ROI directly on the representation of the first image. In another example, the image analysis platform can present a representation of the first image on an interface and overlay, on the representation of the first image, proposed bounds of the first ROI. These proposed bounds may be established through object detection or edge detection as discussed above. Through the interface, the user may be able to confirm, reject, or modify the proposed bounds.

Accordingly, the image analysis platform can use a combination of image processing and user instruction to determine the first ROI. For example, the image analysis platform may receive, from a user, input that identifies an object in the first image, and in response to receiving the input, the image analysis platform can process the first image and the input to detect the object, generate an outline of the object, and determine the first ROI as a region that is representative of the outline of the object. In another example, the image analysis platform can use object detection, edge detection, and/or image segmentation to identify one or more objects of the first image and thereafter receive user input identifying an object that is then used to determine the first ROI.

At 606, the image analysis platform can establish a first value (also called a “baseline value”) for a statistical feature based on an analysis of pixels in the first ROI in the first image. Each pixel in the first ROI of the first image corresponds to a set of color data, such as data in an RGB color space or an HSV color space. The statistical feature can be representative of a quantitative metric such as mean, median, mode, range, standard deviation, variation, root-mean-square average, or any combination thereof. Thus, the first value may be one of a set of values that are established for the first ROI in the first image, and the set of values may be representative of a vector or ordered list of values for two or more statistical features. In some embodiments, the statistical feature is a mean hue value, a mean saturation value, a mean brightness value, or a set of mean hue, saturation, and brightness values. In other embodiments, the statistical feature is a mean red value, a mean green value, a mean blue value, or a set of mean red, green, and blue values. Those skilled in the art will recognize that the nature of the first value may depend on the color space of the pixel data of the first image.

In some implementations, the image analysis platform can process the pixel data before calculating the first value for the statistical feature. For example, the image analysis platform can convert the values of the pixels that are located in the first ROI of the first image from a first color space to a second color space. As a specific example, the first color space can be an RGB color space in which each pixel is represented by a red value, a green value, and a blue value, and the second color space can be an HSV color space in which each pixel is represented by a hue value, a saturation value, and a brightness value. In some implementations, the image analysis platform converts the values of pixels corresponding to a portion of the first image (e.g., the portion contained in the first ROI) rather than pixels across the entirety of the first image.

In some embodiments, the first image is one of multiple images for which the statistical feature is established (e.g., few-shot calibration or many-shot calibration, rather than one-shot calibration). For example, the image analysis platform can determine multiple ROIs corresponding to multiple images, calculate multiple values for a statistical feature based on the pixels in the respective ROIs of the multiple images, and determine the first value for the statistical feature as a function of the multiple values. As a specific example, the image analysis platform could calculate multiple mean hue values based on an analysis of the respective ROIs of multiple images and then determine the first value as the average of the multiple mean hue values. In another example, the image analysis platform can calculate, for each of the respective ROIs of the multiple images, a mean brightness value and a brightness standard deviation based on an analysis of the pixels contained therein, and then the image analysis platform can determine the first value to be the ordered list containing the average of the mean brightness values and the average of the brightness standard deviations. In another example, the first value can be representative of an average of the multiple values established for the multiple images. Accordingly, the image analysis platform can establish the first value based on a single value of a statistical feature that is established for a single image, a set of values of a set of statistical features that is established for a single image, multiple values of the statistical feature that are established for multiple images, or multiple sets of values for a set of statistical features that are established for multiple images.

In some embodiments, the image analysis platform transform the pixel data that corresponds to the respective ROIs of the multiple images before calculating a statistical feature For example, the image analysis platform can transform pixel values from the RGB color space into the HSV color space and then calculate one or more statistical features, resulting in values that are in the HSV color space. The image analysis platform can perform the same transformation on all of the images. Furthermore, the image analysis platform can perform this transformation on all the pixels of an image, or only a subset, such as only transforming pixel values for pixels in the ROI of an image. The number of images that are used for calibrating an appropriate value for the one or more statistical features can be equal to or larger than a predetermined number (e.g., 2, 5, 10, 25, 50, 100, 1000, or any other number). The image analysis platform can also dynamically determine the number based on a set of conditions. For example, the image analysis platform can take the average of a number of mean hue values, where the number is set as the image analysis platform receives images such that the standard deviation of the average is at or below a certain value.

At 608, the image analysis platform can determine a second ROI in a second one of the series of images that corresponds to a second one of the series of times. While the second time is subsequent to the first time, the second image need not necessarily be directly adjacent to the first image in the series of images. In fact, the image analysis platform may be designed to analyze images at a predetermined cadence in order to conserve computational resources. The predetermined cadence may be based on the rate at which images are generated and/or received, as well as the granularity needed to establish changes in state. For example, if an image capture device is configured to capture images of a scene at a rate of 20 frames per second, the image analysis platform may analyze one or two frames per second, one frame every two or three seconds, etc. Accordingly, the image analysis platform may sample a stream of images output by the image capture device in order to periodically determine whether there has been a change in state.

The second ROI can correspond to the same portion of the second image, and therefore the same region of the scene, as the first ROI of the first image. For example, the second ROI of the second image can have the same bounds as the first ROI of the first image (e.g., include the same pixel positions). This approach may be suitable for embodiments where the image capture device is not likely to move, and therefore is likely to capture the same region of the scene in each image. If different regions of the scene are captured by the image capture device over time, then the image analysis platform may determine the second ROI in a more dynamic manner, as the goal is for the second ROI to correspond to the same region of the scene as the first ROI. This can be accomplished using computer vision techniques (e.g., object detection, edge detection, and image segmentation to determine the outline of the object identified in the first ROI) or by other means (e.g., using accelerometers to track the change in position of the imaging device to calculate a change in the point of view of the images). In some implementations, the image analysis platform receives the second image after receiving the first image and determining the baseline values for the one or more statistical features.

At 610, the image analysis platform can establish a second value for the statistical feature based on an analysis of pixels in the second ROI in the second image. The analysis can be substantially identical to the analysis performed on the pixels in the first ROI of the first image. For example, if the image analysis platform converted pixel values for the first ROI of the first image and/or multiple ROIs of multiple images, then the image analysis platform can also convert the values of the pixels that are located in the second ROI of the second image (e.g., converting the values from the first color space to the second color space, such as from RGB color space to HSV color space).

At 612, the image analysis platform can compare the first and second values to determine whether the second value deviates beyond a threshold from the first value. For example, the image analysis platform can determine that the second value deviates from the first value by a threshold amount. This can include taking a difference between the first and second values and comparing it to a threshold distance. The threshold distance can be set by a user, can be a predetermined value, and/or can be set algorithmically (e.g., the threshold distance can be set to a multiple of a standard deviation). If the first and second values include multiple values (e.g., in an ordered list), the image analysis platform can compare each value independently to determine if the second value deviates from the first value. For instance, if the first and second values each contain three values, then the image analysis platform can determine a deviation by a threshold amount if two of the three values deviate by respective threshold amounts. The image analysis platform can also use a combination thereof (e.g., a basic combination or weighted combination) to determine a deviation by a threshold amount (e.g., treating the values in the first and second values as independent dimensions and comparing the Euclidean distance between them to a threshold value).

The image analysis platform can then take actions in response to this determination. The actions taken can vary depending on the intent and configuration of the image analysis platform. For example, at 614, the image analysis platform can respond to the determination that the second value deviates from the first value by the threshold amount by indicating in a data structure that the second image is an anomalous image, so as to document that an inferred state of the scene has changed between the first and second times corresponding to the times corresponding with the first and second images. More generally, the image analysis platform can store and save an indication of the determination in a storage medium. The storage medium may form part of the computing system on which the image analysis platform is executing, or the storage medium may be accessible to the computing system on which the image analysis platform is executing via a network (e.g., the Internet). The indication can include other relevant information, such as the first value, the second value, the first time at which the first image was captured, the second time at which the second image was captured, or a time at which the determination was made.

In some embodiments, the second image is further analyzed by the image analysis platform. For instance, the image analysis platform can cause an ML model to be applied to the second image. This can occur at the computing system on which the image analysis platform is executing, or the second image can be transmitted to a destination that is external to the computing device on which the image analysis platform is executing for application of the ML model. More generally, the image analysis platform can process the image - or cause the image to be processed - using any number of heuristics, algorithms, or ML models to extract information from the image.

The image analysis platform can also use images in the series to improve its accuracy. This can overlap with the calibration operation, in which multiple images are used to determine the first value of the statistical feature. In some implementations, the image analysis platform can establish a second threshold, such that a deviation from the second threshold prompts the image analysis platform to recalibrate and recalculate the first value for the statistical feature. The second threshold can be contained inside the first threshold that is used to infer a change in state of the scene (e.g., the second threshold can be nearer the first value than the first threshold). A value for the statistical feature can deviate from the second threshold but not the first threshold, for instance, if the scene is changing slowly in a way that is not indicative of a change of state (e.g., a change in weather and/or a change in the time of day).

Further, the image analysis platform can determine a third ROI in a third image and calculate a third value for the statistical feature. The image analysis platform can determine whether the third value deviates from the first value by the second threshold amount that is less than the first threshold amount used to infer a change in state of the scene. In response to a determination that the third value does deviate from the first value by the second threshold amount, the image analysis platform can establish the third value for the statistical feature as a reference against which subsequent values are compared (e.g., the system can update the first value to be equal to the third value, which is then used as a reference for measuring deviations).

In some embodiments, the image analysis platform can use information contained in a third image, corresponding to a third time that lies between the first and second times corresponding to the first and second images, to determine a third ROI in a third one of the series of images that corresponds to a third one of the series of times that is subsequent to the first time but before the second time. The third ROI of the third image can correspond to the first ROI of the first image, such as when the third ROI has the same bounds as the first ROI of the first image. The image analysis platform can establish a third value for the statistical feature based on an analysis of pixels in the third ROI in the third image and compare the first and third values to determine whether the third value deviates from the first value by a threshold amount. In response to a determination that the third value does not deviate from the first value by the threshold amount, the image analysis platform can indicate, in a data structure, that the third image is comparable to the first image, so as to document that an inferred state of the scene has not changed between the first and third times. In some embodiments, the third image is captured by an image capture device at least a predetermined amount of time after the first image is captured by the image capture device.

### Network Environment

FIG. 7 illustrates a network environment 700 that includes an image analysis platform 702 that is executed by a computing device 704. An example of a computing device, such as computing device 704, is described in more detail with respect to FIG. 8. An individual (also referred to as a “user”) can interact with the image analysis platform 702 via interfaces 706. Although one computing device 704 is shown in FIG. 7, the image analysis platform 702 can in general be executed by one or more computing devices.

As shown in FIG. 7, the image analysis platform 702 can reside in a network environment 700. Thus, the computing device 704 on which the image analysis platform 702 resides can be connected to one or more networks 708A-B. Depending on its nature, the computing device 704 could be connected to a personal area network (“PAN”), local area network (“LAN”), wide area network (“WAN”), metropolitan area network (“MAN”), or cellular network. For example, if the computing device 704 is a computer server, then the computing device 704 may be accessible to users via respective mobile phones that are connected to the Internet via LANs. This can allow the users of the mobile phones to receive information and updates pertaining to the analysis performed by the image analysis platform 702.

Additionally, or alternatively, the computing device 704 may be connected to one or more other computing devices over a short-range wireless connectivity technology, such as Bluetooth®, Near Field Communication (“NFC”), Wi-Fi® Direct (also referred to as “Wi-Fi P2P”), and the like. As an example, the image analysis platform 702 could be embodied as an application that is executed by an IoT device. In such embodiments, the IoT device may be communicatively connected - via a wireless communication channel - to a server where changes in the state of a scene captured by the device are reported.

The interfaces 706 may be accessible via a web browser, desktop application, mobile application, or another form of computer program. For example, a user may be able to access interfaces through which information about the image analysis platform 704 are presented. Such information can include, for example, a representation of one or more of the images used by the image analysis platform 704, which can include one or more analyzed images, a live feed of captured video, images of the most recent detected changes in state of the scene being captured, and the like, which can be presented sequentially or simultaneously. The information about the image analysis platform 704 can further include data about the analysis, such as the statistical features being calculated, the amount of time during which the scene was detected to be in certain states, timestamps for the detected changes in state of the scene, a representation of an ROI in an image, and the like. Accordingly, the interfaces 706 generated by the image analysis platform 702 may be accessible on various computing devices, including mobile phones, tablet computers, desktop computers, and the like.

The image analysis platform 702 can be executed - at least partially - by a cloud computing service operated by, for example, Amazon Web Services®, Google Cloud Platform™, or Microsoft Azure®. Thus, the computing device 704 may be representative of a computer server that is part of a server system 710. Often, the server system 710 is comprised of multiple computer servers. These computer servers can include different types of data, algorithms for processing incoming data, and other assets. Those skilled in the art will recognize that these data could also be distributed among the server system 710 and one or more computing devices.

Components of the image analysis platform 702 could also be hosted locally. That is, part of the image analysis platform 702 may reside on the computing device used to access one of the interfaces 706. For example, the image analysis platform 702 may be embodied as an application executing on a IoT device as mentioned above. Note, however, that the application may be communicatively connected to the server system 710 on which other components of the image analysis platform 702 are hosted.

Accordingly, various computing components of the network environment 700 can be identified with the lightweight system 104 and the advanced system 116 discussed above with respect to FIG. 1. In an example, the image analysis platform 702 may be hosted on an IoT device that is representative of the lightweight system 104 and which reports data to a personal computer, which is representative of the advanced system 116. In another example, the image analysis platform 702 is hosted on a computing device 704 that is representative of the lightweight system 104 and which reports data to the server system 710, which is representative of the advanced system 116. In yet another example, the image analysis platform 702 is hosted on a first server of the server system 710 that is representative of the lightweight system 104 and which reports data to a second server of the server system 710, which is representative of the advanced system 116. The first server can receive image data through the network environment 700 and can be part of a cloud computing service that is the same as, or different than, a cloud computing service that operates the second server. In yet another example, part of the image analysis platform 702 is hosted on a computing device - like a mobile phone or IoT device - that is representative of the lightweight system 104 while part of the image analysis platform 702 is hosted on either another, more robust computing device - like a personal computer or server - that is representative of the advanced system 116.

### Computer System

FIG. 8 illustrates an example of a computing device that is designed to infer a characteristic of a scene based on an analysis of color implemented through a computer program executing on a computing device. As shown in FIG. 8, the computing device 800 can include a processor 802, memory 804, display mechanism 806, communication module 808 and image sensor 810. Each of these components is discussed in greater detail below.

Those skilled in the art will recognize that different combinations of these components may be present depending on the nature of the computing device 800. For example, if the computing device 800 is a computer server that is part of a server system (e.g., server system 710 of FIG. 7), then the computing device 800 may not include the display mechanism 806 or image sensor 810. Conversely, if the computing device 800 is a mobile phone, then the computing device 800 can include the display mechanism 806 and image sensor 810.

As further discussed below, the computing device 800 on which the image analysis platform 812 resides may not include sensors in some embodiments. In such embodiments, the data examined by the image analysis platform 812 could instead be generated by one or more image sensors 822A-N that are external to the computing device 800. For example, the computing device 800 may be a mobile phone, and the image sensors 822A-N may be included in a camera or IoT device that is communicatively connected to the computing device 800.

The processor 802 can have generic characteristics similar to general-purpose processors, or the processor 802 may be an application-specific integrated circuit (“ASIC”) that provides control functions to the computing device 800. The processor 802 can be designed to require a reduced amount of resources as compared to general-purpose processors. As shown in FIG. 8, the processor 802 can be coupled to all components of the computing device 800, either directly or indirectly, for communication purposes.

The memory 804 can be comprised of any suitable type of storage medium, such as static random-access memory (“SRAM”), dynamic random-access memory (“DRAM”), electrically erasable programmable read-only memory (“EEPROM”), flash memory, or registers. In addition to storing instructions that can be executed by the processor 802, the memory 804 can also store data generated by the processor 802 (e.g., when executing the modules of the image analysis platform 812). Note that the memory 804 is merely an abstract representation of a storage environment. The memory 804 could be comprised of actual integrated circuits (also called “chips”).

The display mechanism 806 can be any mechanism that is operable to visually convey information to a user. For example, the display mechanism 806 can be a panel that includes light-emitting diodes (“LEDs”), organic LEDs, liquid crystal elements, or electrophoretic elements. As further discussed below, outputs produced by the image analysis platform 812 (e.g., through execution of its modules) can be posted to the display mechanism 806 for review by a user of the computing device 800. The display mechanism 806 can also include input sensors. For example, the display mechanism 806 can be a touchscreen that accepts user input via touch.

The communication module 808 may be responsible for managing communications external to the computing device 800. The communication module 808 can be wireless communication circuitry that is able to establish wireless communication channels with other computing devices. Examples of wireless communication circuitry include 2.4 gigahertz (“GHz”) and 5 GHz chipsets compatible with Institute of Electrical and Electronics Engineers (“IEEE”) 802.11 - also referred to as “Wi-Fi chipsets.” Alternatively, the communication module 808 may be representative of a chipset configured for Bluetooth, NFC, and the like. Some computing devices - like mobile phones, tablet computers, and the like - are able to wirelessly communicate via separate channels, while other computing devices - like IoT devices - tend to wirelessly communicate via a single channel. Accordingly, the communication module 808 may be one of multiple communication modules implemented in the computing device 800, or the communication module 808 may be the only communication module implemented in the computing device 800.

The nature, number, and type of communication channels established by the computing device 800 - and more specifically, the communication module 808 - can depend on (i) the sources from which data is received by the image analysis platform 812 and (ii) the destinations to which data is transmitted by the image analysis platform 812. Assume, for example, that the image analysis platform 812 resides on a mobile phone in the form of a mobile application. In such embodiments, the communication module 808 can communicate with image sensors 822A-N external to the computing device 800 from which to obtain data. Moreover, the communication module 808 may communicate with a server system (e.g., server system 710 of FIG. 7) to which analyses of the data- or the data itself - are transmitted.

The image sensor 810 may be capable of recording images and/or video for the computing device 800. Although one image sensor 810 is shown in FIG. 8, it can be appreciated that computing device 800 can in general include one or more image sensors 810. Furthermore, the computing device 800 can have image sensors of various types, including visible light sensors, infrared image sensors, multispectral image sensors, time-of-flight image sensors, event-based images sensors, and the like. These image sensors can be incorporated into larger components - such as infrared cameras, high-speed cameras, omnidirectional cameras, and the like - that are included with computing device 800.

As mentioned above, data could also be acquired from image sensors 822A-N that are external to the computing device 800. These image sensors 822A-N could be included in another computing device, such as a digital camera or IoT device, that is directly connected to the computing device 800. Alternatively, these image sensors 822A-N could be discrete sensing units that are directly or indirectly connected to the computing device 800.

For convenience, the image analysis platform 812 is referred to as a computer program that resides within the memory 804. However, the image analysis platform 812 could be comprised of software, firmware, or hardware that is implemented in, or accessible to, the computing device 800. In accordance with embodiments described herein, the image analysis platform 812 can include a processing module 814, computation module 816, and graphical user interface (“GUI”) module 818. These modules could be integral parts of the image analysis platform 812, or these modules could be logically separate from the image analysis platform 812 but operate “alongside” it. Together, these modules can enable the image analysis platform 812 to infer information about a scene, such as a scene captured by the image sensor 810 and/or the image sensors 822A-N.

The processing module 814 can process data obtained by the image analysis platform 812 into a format that is suitable for the other modules. For instance, the processing module 814 can apply operations to image sensor data obtained from the image sensor 810 or image sensors 822A-N in preparation for analysis by the other modules of the image analysis platform 812. In an example, the processing module 814 can transform image data, such as transforming pixel values from an RGB color space to an HSV color space. In another example, the processing module 814 can filter image data, such as by choosing only a subset of images from a video stream to perform an analysis on, or by isolating pixels in an ROI of an image. Accordingly, the processing module 814 may be responsible for ensuring that the appropriate data is accessible to the other modules of the image analysis platform 812.

The computation module 816 (also called a “computation system”) may be responsible for computing values for statistical features of the received image data. That is, the computation module 816 may receive data - for example, from the processing module 814 - and perform a set of calculations on the data based on predetermined settings, such as a choice of one or more statistical features. The computation module 816 may be responsible for comparing values to infer information about a scene depicted in received image data. For example, the computation module 816 can compare computed values for statistical features between two or more images and detect a threshold difference between the values.

The GUI module 818 may be responsible for generating interfaces that are viewable on the display mechanism 806. Various types of information can be presented on these interfaces. For example, one or more images captured by the image sensor 810 and/or the image sensor 822A-N can be displayed, along with computed values for statistical features. In some embodiments, the computing device 800 can allow a user to interact with the computing device 800 via the display mechanism 806. The GUI module 818 may allow a user to choose parameters, using the display mechanism 806, for the image analysis platform 812 to use. For example, the GUI module 818 can display an image of a scene using display mechanism 806 and capture user input that defines a portion of the image. This portion can then be used as an ROI for the image analysis platform 812 to analyze and compute values for statistical features.

FIG. 9 includes a block diagram illustrating an example of a processing system 900 in which at least some operations described herein can be implemented. For example, components of the processing system 900 may be hosted on a lightweight system (e.g., lightweight system 104) or an advanced system (e.g., advanced system 116) that includes an image analysis platform (e.g., image analysis platform 702 of FIG. 7 or image analysis platform 812 of FIG. 8).

The processing system 900 can include a processor 902, main memory 906, non-volatile memory 910, network adapter 912, video display 918, input/output devices 920, control device 922 (e.g., a keyboard or pointing device, such as a computer mouse or trackpad), drive unit 924 including a storage medium 926, and signal generation device 930 that are communicatively connected to a bus 916. The bus 916 is illustrated as an abstraction that represents one or more physical buses or point-to-point connections that are connected by appropriate bridges, adapters, or controllers. The bus 916, therefore, can include a system bus, a Peripheral Component Interconnect (“PCI”) bus or PCI-Express bus, a HyperTransport (“HT”) bus, an Industry Standard Architecture (“ISA”) bus, a Small Computer System Interface (“SCSI”) bus, a Universal Serial Bus (“USB”) data interface, an Inter-Integrated Circuit (“I²C”) bus, or a high-performance serial bus developed in accordance with Institute of Electrical and Electronics Engineers (“IEEE”) 1394.

While the main memory 906, non-volatile memory 910, and storage medium 926 are shown to be a single medium, the terms “machine-readable medium” and “storage medium” should be taken to include a single medium or multiple media (e.g., a centralized/distributed database and/or associated caches and servers) that store one or more sets of instructions 928. The terms “machine-readable medium” and “storage medium” shall also be taken to include any medium that is capable of storing, encoding, or carrying a set of instructions for execution by the processing system 900.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in a computing device. When read and executed by the processor 902, the instruction(s) cause the processing system 900 to perform operations to execute elements involving the various aspects of the present disclosure.

Further examples of machine- and computer-readable media include recordable-type media, such as volatile memory and non-volatile memory 910, removable disks, hard disk drives, and optical disks (e.g., Compact Disk Read-Only Memory (“CD-ROMs”) and Digital Versatile Disks (“DVDs”)), and transmission-type media, such as digital and analog communication links.

The network adapter 912 enables the processing system 900 to mediate data in a network 914 with an entity that is external to the processing system 900 through any communication protocol supported by the processing system 900 and the external entity. The network adapter 912 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

In some embodiments, aspects of the present disclosure may relate to at least one non-transitory, computer-readable storage medium with instructions recorded thereon may be provided that, when executed by at least one processor of a computing device, cause the computing device to: receive a series of images of a scene that are captured by an image capture device and that are arranged in temporal order; determine a first region of interest (ROI) in a first image in the series of images that corresponds to a first time in a series of times; establish a first value for a statistical feature based on an analysis of the first ROI in the first image; determine a second ROI in a second image in the series of images that corresponds to a second time in the series of times; establish a second value for the statistical feature based on an analysis of the second ROI in the second image; and compare the first and second values to determine whether the second value deviates from the first value by a first threshold amount.

In one or more embodiments, the second time is subsequent to the first time. In some implementations, the second ROI of the second image has the same bounds as the first ROI of the first image.

In some embodiments, in response to a determination that the second value deviates from the first value by the first threshold amount, the instructions may further cause the computing device to indicate, in a data structure, that the second image is an anomalous image, so as to document that an inferred state of the scene has changed between the first and second times.

In some aspects, the instructions further cause the computing device to receive an indication that an object is present in the first image, and process the first image with an edge detection algorithm, so as to generate an outline of the object, wherein the first ROI is representative of the outline of the object.

In some implementations, the instructions further cause the computing device to apply, to the first image, a machine learning model that is designed and trained to detect instances of the object.

In some embodiments, the instructions further cause the computing device to receive, via an interface, input from a user that defines bounds of a user-defined region of the first image, wherein the first ROI is representative of the user-defined region.

In some aspects, the first image is one of multiple images in the series of images for which the statistical feature is established, and the instructions further cause the computing device to synthesize the first value based on multiple values of the statistical feature that are established for the multiple images.

In some implementations, the first value is representative of an average of the multiple values established for the multiple images.

In some embodiments, the instructions further cause the computing device to: determine a third ROI in a third image in the series of images that corresponds to a third time in the series of times that is subsequent to the first time but before the second time, wherein the third ROI of the third image has the same bounds as the first ROI of the first image; establish a third value for the statistical feature based on an analysis of the third ROI in the third image; compare the first and third values to determine whether the third value deviates from the first value by a second threshold amount; and in response to a determination that the third value does not deviate from the first value by the second threshold amount, indicate, in a data structure, that the third image is comparable to the first image, so as to document that an inferred state of the scene has not changed between the first and third times.

In some aspects, the instructions further cause the computing device to determine whether the third value deviates from the first value by the second threshold amount that is less than the first threshold amount, and in response to a determination that the third value does deviate from the first value by the second threshold amount, establish the third value for the statistical feature as a reference against which subsequent values are compared.

In one or more embodiments, aspects of the present disclosure may relate to at least one non-transitory, computer-readable storage medium with instructions recorded thereon may be provided that, when executed by at least one processor of a computing device, cause the computing device to: acquire a first image of a scene that is captured by an image capture device at a first time; identify a first region in the first image that corresponds to a predetermined portion of the scene; establish a first value for a statistical feature based on an analysis of pixel values of pixels that are located in the first region of the first image; acquire a second image of the scene that is captured by the image capture device at a second time that is subsequent to the first time; identify a second region in the second image that corresponds to the predetermined portion of the scene; establish a second value for the statistical feature based on an analysis of pixel values of pixels that are located in the second region of the second image; and indicate, in a data structure, whether a state of the scene has changed, as determined based on a comparison of the second value to the first value.

In some aspects, the instructions further cause the computing device to, in response to a determination that the second value deviates from the first value by at least a predetermined amount, cause a machine learning model to be applied to the second image.

In some implementations, the second image is transmitted to a destination external to the computing device for application of the machine learning model.

In some embodiments, the instructions further cause the computing device to: convert the pixel values of the pixels that are located in the first region of the first image from a first color space to a second color space; and convert the pixel values of the pixels that are located in the second region of the second image from the first color space to the second color space.

In some aspects, the first color space is a Red-Green-Blue (RGB) color space in which each pixel is represented by a red value, a green value, and a blue value, and the second color space is a Hue-Saturation-Value (HSV) color space in which each pixel is represented by a hue value, a saturation value, and a brightness value.

In some implementations, the statistical feature is a mean hue value, a mean saturation value, a mean brightness value, or a set of mean hue, saturation, and brightness values.

In some embodiments, aspects of the present disclosure may relate to a computer-implemented method of inferring a state of a scene or detecting a presence in the scene based on first and second values of a statistical feature of pixel values of pixels in a first and second image may be provided, the method comprising: determining a first value for the statistical feature based on an analysis of pixel values of pixels that are located in a first region of the first image; determining a second value for the statistical feature based on an analysis of pixel values of pixels that are located in a second region of the second image; and determining whether the second value deviates from the first value by at least a threshold amount.

In some aspects, the method further comprises, in response to a determination that the second value deviates from the first value by at least the threshold amount, causing a machine learning model to be applied to the second image.

In some implementations, the method further comprises presenting, on an interface, a representation of the first image; and receiving, from the interface, an indication of the first region in the first image.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the present disclosure. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for’’ in any other context is not intended to invoke a similar interpretation. The applicant reserves the right to pursue such additional claim forms either in this application or in a continuing application.

What is claimed is:

1. At least one non-transitory, computer-readable storage medium with instructions recorded thereon that, when executed by at least one processor of a computing device, cause the computing device to:
receive a series of images of a scene that are captured by an image capture device and that are arranged in temporal order;
determine a first region of interest (ROI) in a first image in the series of images that corresponds to a first time in a series of times;
establish a first value for a statistical feature based on an analysis of the first ROI in the first image;
determine a second ROI in a second image in the series of images that corresponds to a second time in the series of times;
establish a second value for the statistical feature based on an analysis of the second ROI in the second image; and
compare the first and second values to determine whether the second value deviates from the first value by a first threshold amount.

2. The at least one non-transitory, computer-readable storage medium of claim 1, wherein the second time is subsequent to the first time.

3. The at least one non-transitory, computer-readable storage medium of claim 1, wherein the second ROI of the second image has the same bounds as the first ROI of the first image.

4. The at least one non-transitory, computer-readable storage medium of claim 1, wherein in response to a determination that the second value deviates from the first value by the first threshold amount, indicating, in a data structure, that the second image is an anomalous image, so as to document that an inferred state of the scene has changed between the first and second times.

5. The at least one non-transitory, computer-readable storage medium of claim 1, wherein the instructions further cause the computing device to:
receive an indication that an object is present in the first image; and
process the first image with an edge detection algorithm, so as to generate an outline of the object; and
wherein the first ROI is representative of the outline of the object.

6. The at least one non-transitory, computer-readable storage medium of claim 5, wherein the instructions further cause the computing device to:
apply, to the first image, a machine learning model that is designed and trained to detect instances of the object.

7. The at least one non-transitory, computer-readable storage medium of claim 1, wherein the instructions further cause the computing device to:
receive, via an interface, input from a user that defines bounds of a user-defined region of the first image; and
wherein the first ROI is representative of the user-defined region.

8. The at least one non-transitory, computer-readable storage medium of claim 1, wherein the first image is one of multiple images in the series of images for which the statistical feature is established, and wherein the instructions further cause the computing device to:
synthesize the first value based on multiple values of the statistical feature that are established for the multiple images.

9. The at least one non-transitory, computer-readable storage medium of claim 8, wherein the first value is representative of an average of the multiple values established for the multiple images.

10. The at least one non-transitory, computer-readable storage medium of claim 1, wherein the instructions further cause the computing device to:
determine a third ROI in a third image in the series of images that corresponds to a third time in the series of times that is subsequent to the first time but before the second time,
wherein the third ROI of the third image has the same bounds as the first ROI of the first image;
establish a third value for the statistical feature based on an analysis of the third ROI in the third image;
compare the first and third values to determine whether the third value deviates from the first value by a second threshold amount; and
in response to a determination that the third value does not deviate from the first value by the second threshold amount,
indicating, in a data structure, that the third image is comparable to the first image, so as to document that an inferred state of the scene has not changed between the first and third times.

11. The at least one non-transitory, computer-readable storage medium of claim 10, wherein the instructions further cause the computing device to:
determine whether the third value deviates from the first value by the second threshold amount that is less than the first threshold amount; and
in response to a determination that the third value does deviate from the first value by the second threshold amount, establish the third value for the statistical feature as a reference against which subsequent values are compared.

12. At least one non-transitory, computer-readable storage medium with instructions recorded thereon that, when executed by at least one processor of a computing device, cause the computing device to:
acquire a first image of a scene that is captured by an image capture device at a first time;
identify a first region in the first image that corresponds to a predetermined portion of the scene;
establish a first value for a statistical feature based on an analysis of pixel values of pixels that are located in the first region of the first image;
acquire a second image of the scene that is captured by the image capture device at a second time that is subsequent to the first time;
identify a second region in the second image that corresponds to the predetermined portion of the scene;
establish a second value for the statistical feature based on an analysis of pixel values of pixels that are located in the second region of the second image; and
indicate, in a data structure, whether a state of the scene has changed, as determined based on a comparison of the second value to the first value.

13. The at least one non-transitory, computer-readable storage medium of claim 12, wherein the instructions further cause the computing device to:
in response to a determination that the second value deviates from the first value by at least a predetermined amount,
cause a machine learning model to be applied to the second image.

14. The at least one non-transitory, computer-readable storage medium of claim 13, wherein the second image is transmitted to a destination external to the computing device for application of the machine learning model.

15. The at least one non-transitory, computer-readable storage medium of claim 12, wherein the instructions further cause the computing device to:
convert the pixel values of the pixels that are located in the first region of the first image from a first color space to a second color space; and
convert the pixel values of the pixels that are located in the second region of the second image from the first color space to the second color space.

16. The at least one non-transitory, computer-readable storage medium of claim 15, wherein the first color space is a Red-Green-Blue (RGB) color space in which each pixel is represented by a red value, a green value, and a blue value, and
wherein the second color space is a Hue-Saturation-Value (HSV) color space in which each pixel is represented by a hue value, a saturation value, and a brightness value.

17. The at least one non-transitory, computer-readable storage medium of claim 12, wherein the statistical feature is a mean hue value, a mean saturation value, a mean brightness value, or a set of mean hue, saturation, and brightness values.

18. A computer-implemented method of inferring a state of a scene or detecting a presence in the scene based on first and second values of a statistical feature of pixel values of pixels in a first and second image, the method comprising:
determining a first value for the statistical feature based on an analysis of pixel values of pixels that are located in a first region of the first image;
determining a second value for the statistical feature based on an analysis of pixel values of pixels that are located in a second region of the second image; and determining whether the second value deviates from the first value by at least a threshold amount.

19. The computer-implemented method of claim 18, further comprising:
in response to a determination that the second value deviates from the first value by at least the threshold amount,
cause a machine learning model to be applied to the second image.

20. The computer-implemented method of claim 18, further comprising:
presenting, on an interface, a representation of the first image; and
receiving, from the interface, an indication of the first region in the first image.
